(19) United States
(12) Patent Application Publication
(10) Pub. No.: US 2018/0165713 A1
(43) Pub. Date: Jun. 14, 2018

(54) Virtual Advertising Database with Command Input Data

(71) Applicant: David Joseph O'Hanlon, Raleigh, NC (US)

(72) Inventor: David Joseph O'Hanlon, Raleigh, NC (US)

(21) Appl. No.: 15/424,854

(22) Filed: Feb. 5, 2017

Related U.S. Application Data
(60) Provisional application No. 62/433,790, filed on Dec. 14, 2016.

(51) Int. Cl. G06Q 30/02

(52) U.S. Cl. CPC G06Q 30/0257; G06T 19/006; G06Q 30/0273; G06Q 30/0276

(57) ABSTRACT

Virtual reality devices bring a new type of advertisement preference input command data. The data comes from a source of having your eyes at least partially viewing the sight of a virtual experience. For this reason, and many more, it is very important that this new generation of devices, as they exist and develop, control the advertisements the virtual reality device owners see and react to in the awe struck environment of something new. In order to do this, they will need many different ways to send commands at different points and complexities of advertisements, especially to enjoy the experience of this new device that would otherwise be lost in advertisements that have no ability to coexist without the participants giving orders of what they want to see.

### RELATED APPLICATIONS

This application claims benefit of provisional U.S. application Ser. No. 62/433,790, filed Dec. 14, 2016.

### FIELD OF THE INVENTION

The present invention relates to the field of database advertising in virtual reality.

### BACKGROUND OF THE INVENTION

The typical computer uses a mouse or touch-screen to access advertisement objects. These advertisement objects are clicked on by a mouse on the internet. For a very long time, there has been the advancement of this device which has only become a peripheral device by USB for the most part. Although, mainly, how it has been used remains relatively unchanged.

Touch-screen was a big advance and changes were needed by using your fingers to click and zoom in and out of advertisement objects. This was something customers had to adjust to.

There was also the handy stylus which largely emboldened artists and techies to write on the typical tablet or computer screen.

However, now there is a total revamp of tools that are just coming to market. And they haven't scratched the surface with virtual reality and all the advancements in technology. All of the above have been used in the current market for database advertising on the internet. But now we usher in virtual reality and what to do here.

Moreover, many items are on the market in the computer field and advertise digitally. But there are only a few that have major impacts that revolutionize the way we think, see, and act to react to the items of new virtual reality devices.

In the present invention it introduces that virtual reality devices change the realm of what tools you need to complete a task to react to advertisement objects. Each new type of virtual reality gear equips a person the need to understand the new set of rules of operation. This is significant with this generation of device. A hand swipe motion may be picked up by a sensor. And a different sensor that is worn may designate the space by wearing it on your hand or wrist.

For example, these motions connect with the device as a comprehensive command input data preference for advertisements.

A set of further examples therefore starts as simple as passing a hand motion in front of a virtual reality device sensor which may insert an advertising image or make an assist on skipping the image completely. Or perhaps a virtual reality vest that detects excitement by a deep breath during an advertisement. These virtual advertisement preference command input data can be captured and used for multiple users to deliver better advertisements.

Second, the virtual reality devices will have a new advertisement scheme such as audio and microphone virtual reality or mixed reality and augmented reality. Mixed reality and augmented reality are the integration of virtual reality with that of the real world. Indeed, advertisements need new advertisement preference command input data to distinguish reactions.

Third, virtual reality devices can still provide more by allowing databases the advertisement schemes preference data to be realized for digital ad iterations to evolve.

However, it is not known to use common movements and devices with a digital ad database analysis of new advertisement preference command input data with virtual reality devices.

### OBJECTS OF THE INVENTION

It is therefore an object of the present invention to assist computer engineers to use the predicated advertisement preference command input data motions, button clicks, microphone and speaker directions, mechanical slides, peripheral gadgets motions, such as, computer game golf club motions, three dimensional objects reached outside the virtual reality devices, and stop and move from GPS location to location, to result in the next best available advertisement view by the user.

It is also another object of the present invention to use an algorithm which is a step by step computer process to achieve better advertisements by their average data weight value for multiple users.

It is yet another object of the present invention to have new advertisement command input data in updates for users as virtual reality devices are updated.

It is a further object of the present invention to be as comprehensive a database as possible to mimic the way which human data alteration would supply a digital advertisement to a virtual reality device user.

It is also an object of the present invention to provide the advertisement the user truly desires.

### SUMMARY OF THE INVENTION

In keeping with these objects and others which may become apparent, the present invention includes a system to assist virtual reality device owners the ultimate benefit of the best available advertisement tailored to them by their own advertisement preference command input data in response to advertisements.

For example, virtual reality advertisement objects are different. They accept advertisement preference command input data, such as, body gestures, button clicks, GPS location movement, hand swipe motion in front of a sensor, which must be delivered while at least a portion of the consumers eyes are covered by a virtual reality device at least most of the time. So, the experience of using the devices is different and leaves people awe struck.

In the present invention, the advertising images, video, text, and virtual reality, including each of their three-dimensional counter-parts, are either reintroduced or substituted when more user advertisement preference command input data and system attribute information are analyzed by the database.

Further, the advertising objects need to be cast in a database application computer software system to code to target the user as they are compelled to join in participation with the advertisement objects.

It could also be done at base level and fixed advertising objects in an application can use a simple desktop computer database for usage figures. The database application-data advertising code may replace space between code insertion points in the virtual reality code of microphones and speakers, sensor gloves and display screens, and goggles with other virtual advertisement preference command input data.

It is also useful to note that object-oriented programming allows the build and reuse of the advertisement objects to be received, stored, updated, and transmitted again to, within, and from the database. SQL is one such program that allows this type of programming.

Another advertisement object form of creation process is the user advertiser. It can be a said virtual advertisement object creation begins with a user advertiser of at least one database software coded application for advertisement object building for the at least one user advertiser to deliver at least one created at least one advertisement object to at least one first user.

Java® and Java 3D VR programming are two such advertisement object database software used for coding advertisement objects. These also allow for tracking preferences and demographic attributes to be collected, ranked, checked against one another, and delivered.

Marketing properties for demographics, such as age, income, gender, and variations of user information, can be included in tracking and ranking the movement of these groups of population preferential attributes.

Further, the portion of augmented or mixed reality is possible while integrated within at least one portion of virtual reality comprising visible real-world mixing and matching. For instance, the time to display props with a set of theatrical actors can be reduced by introducing a mix of virtual reality theater design with staged reproductions.

In one embodiment, a virtual reality device and some of the tools for advertisement preference commands are illustrated on the device, and some of those outside it, are all as an example of possibilities.

In another embodiment, a simple no frills database drawing exemplifies the ease of use of a first and second user. This ease spills over as each new user is introduced to become a multiuser platform database. The micro level gives a great introduction.

Alternatively, in another embodiment, a communication network and a network communication module, lie between multiuser and advertiser(s) accessing each others work through a database that is training the advertisement data to deliver better advertisements to achieve the success of product, information, and service categories. These categories can also be preferentially tracked to specific users as IP Addresses or other user device authenticity as measured during button clicks, hand motions, microphone speech recognition, and GPS location stop and go to name a few advertisement preference command input data.

A computer software system, having a method of utilizing at least one advertisement preference command input data within the at least one advertising database application within at least one portion of virtual reality comprising: at least one advertisement object at the at least one comprehensive database is cast to be read by at least one virtual reality device wherein there is an advantage of the at least one first user who inputs at least one virtual advertisement preference command input data in response to the at least one advertisement object to better their preferences and see an ideal advertisement, having at least one more user using at least one advertisement preference command input data in response to the at least one advertisement object that is written to the at least one database, wherein the at least one database alters the advertisement preference command input data to be weighted, such as, by weighing the current advertisement preference command input data value against the advertisements' average value of the two users of this mathematical process algorithm; wherein writes to the database are updated to readable output data wherein the higher than average value advertisement score updates that advertisement to be delivered to potential clients and averaging the consolidated weight in process for the next round and is also stored in the database storage for the next update of the at least one advertisement preference command input data using at least this one algorithm; wherein at least one write within the at least one database are updated at least one readable output data as at least one advertisement object code to be cast to at least one of the first users at least one virtual reality device which receives the at least one code and results in the said advantage preferred advertisement.

A computer software system, having a method of utilizing at least one advertisement preference command input data within the at least one advertising database application within at least one portion of virtual reality comprising;

At least one advertisement object is cast or fixed for at least one first user;

The at least one first user responds with advertisement preference command input data and at least a second user of at least one similar advertisement object follows suit;

An algorithm determines who in answer is better for the advertisement object by processing the at least one advertisement preference command input data;

Wherein at least one of the first users at least one virtual reality device will receive the result of the advantage preferred advertisement object;

A computer software system, having a method of utilizing at least one advertisement preference command input data within the at least one advertising database application within at least one portion of virtual reality comprising;

At least one database software coded application for advertisement object creation for the at least one user advertiser to deliver at least one partly created at least one advertisement object to at least one first user;

The at least one first user responds with advertisement preference command input data and at least a second user of at least one similar advertisement object follows suit;

An algorithm determines who in answer is better for the advertisement object by processing the at least one advertisement preference command input data;

Wherein the advertisement object builds, via writes from the advertising database application, the further attributes and their result is transmitted to database updates to the user advertiser, the user, or stores in the database the advantage preferred advertisement object;

A computer software system, having a method of utilizing at least one advertisement preference command input data within the at least one advertising database application within at least one portion of virtual reality comprising;

The preference tracking and ranking of at least one advertising object assigned attributes by an advertiser user or through user's usage;

The at least one first user responds with advertisement preference command input data and at least a second user of at least one similar advertisement object follows suit;

An algorithm determines who in answer is better for the advertisement object by processing the at least one advertisement preference command input data and checking the advertisement object against the database storage at least one similar advertisement objects' attribute;

Wherein the result of at least one advertisement object and its' attributes rank are assigned at least one database storage and at least one advertisement object is transmitted by higher rank to at least one user virtual device to reiterate the user process which may also transmit results to the user advertiser for information;

The advertisement preference command input data wherein the device uses global positioning system;

The advertisement preference command input data wherein the device uses button clicks;

The advertisement preference command input data wherein the device uses speakers and microphones to hear and speak;

The advertisement preference command input data wherein the device uses motion sensors detection;

The advertisement preference command input data wherein the device uses body gestures;

The advertisement preference command input data wherein the device uses peripheral devices;

The advertisement preference command input data wherein the at least one first user responds multiple times alone or at random alongside multiple users of the same capacity to train the advertisement;

The advertisement preference command input data wherein the device uses the value of at least one in-application, music, video or virtual reality purchase of at least one application;

The advertisement preference command input data wherein the device is valued at stop, pause, rewind, skip, yes, no, buy, sell, or other quantifying command;

The advertisement preference command input data wherein the advertisement is cost per click;

The advertisement preference command input data wherein there is at least one in-application purchase of at least one application;

The advertisement preference command input data wherein there is at least one mixed reality or augmented virtual experiences;

The advertisement objects wherein each text, image, 3-D image, virtual reality, and audible transmitting and receiving delivery, are related objects;

The preference tracking and ranking of virtual reality advertisement objects wherein the attribute is a demographic;

The preference tracking and ranking of virtual reality advertisement objects wherein the attribute is a product;

The preference tracking and ranking of virtual reality advertisement objects wherein the attribute is information;

The preference tracking and ranking of virtual reality advertisement objects wherein the attribute is a service.

### BRIEF DESCRIPTION OF THE DRAWINGS

The present invention can best be understood in conjunction with the accompanying drawings, in which:

FIG. 1 is a three-dimensional view of various embodiments to use with the preferred embodiment.

FIG. 2 is a no frills flow-chart of the preferred embodiment.

FIG. 3 is a highly detailed flow-chart of a more sophisticated embodiment.

### DETAILED DESCRIPTION OF THE INVENTION

It is well known that experienced computer programmers use varied elements in order to work out advertisements for the internet for people to find new things and for advertisements to reach deeper and deeper by exposure to the kinds of things we like. It may be one of the most common things that people enjoy less because of the detached senses of the cell phone or computer tablet advertisement object.

However, the sense of reaction to virtual reality devices is so new that people are excited by the added content. That is why this invention is so important to allow the ability to switch to this new generation of product with new advertisement preference command input data with classes such as product, information, or service.

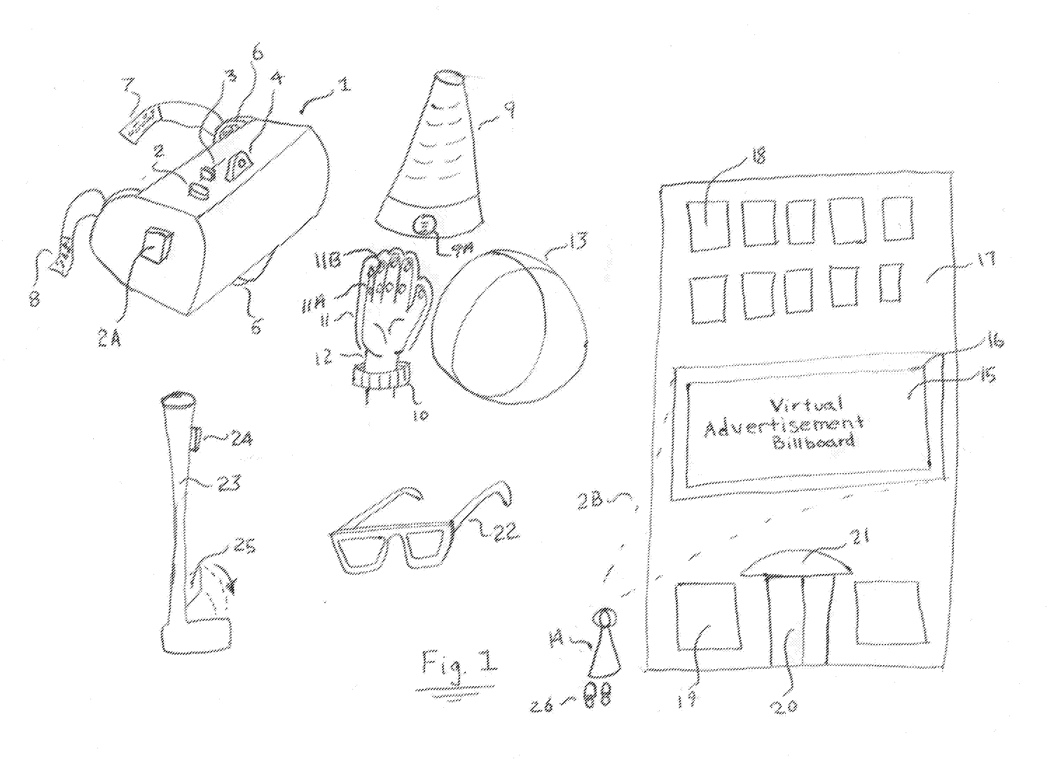

FIG. 1 is virtual reality device 1, button command 2, GPS unit command 2A, slide command 3, motion sensor command 4, microphone command 5, audio advertisement 6, hook fasteners 7, loop fasteners 8. Speaker Advertisement 9 and response microphone 9A, GPS or motion peripheral device command bracelet 10, hand 11, wearing a sensor glove 11A with Sensors 11B as an example of how body gestures are gathered and wrist 12, reach ball 13, as located on a cone shape 14, with GPS located foot prints command to stand in 26, to show a virtual billboard advertisement 15, with border 16, in a virtual reality device portion within viewing sight 28, of building 17, with windows 18 and 19, door 20, and canopy 21. Virtual reality glasses 22 may be used. Golf club peripheral device 23 has button command 24 and open club face range of motion command 25.

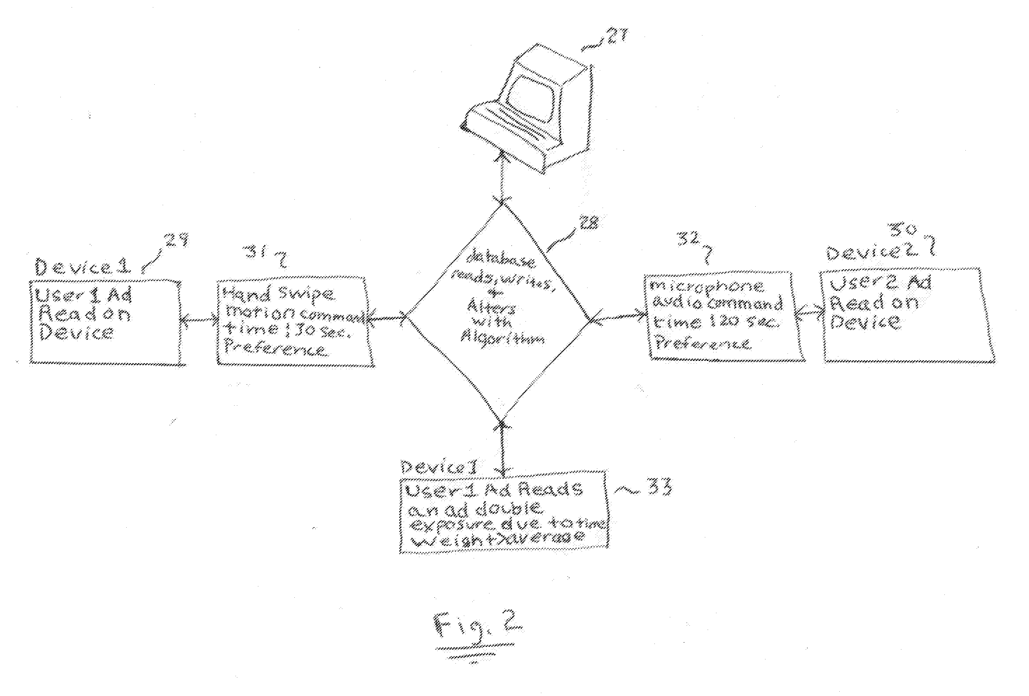

FIG. 2 has advertiser user input 27, reaching virtual reality devices that read data at 29 and 30, users making decision of advertisement preference command input data at 31 for 00:30 seconds of watching an advertisement after a hand swipe motion in front of the devices motion sensor, referring back to FIG. 1 and number 4, and 32 which is a microphone command for 00:20 second advertisement participation, referring back to FIG. 1 and number 5 for the command origin, altered 28 in comprehensive database, and new advertisement read for new reaction to the virtual reality device 33 due to time average weight of 00:25 greater 00:30 seconds as in the algorithm process.

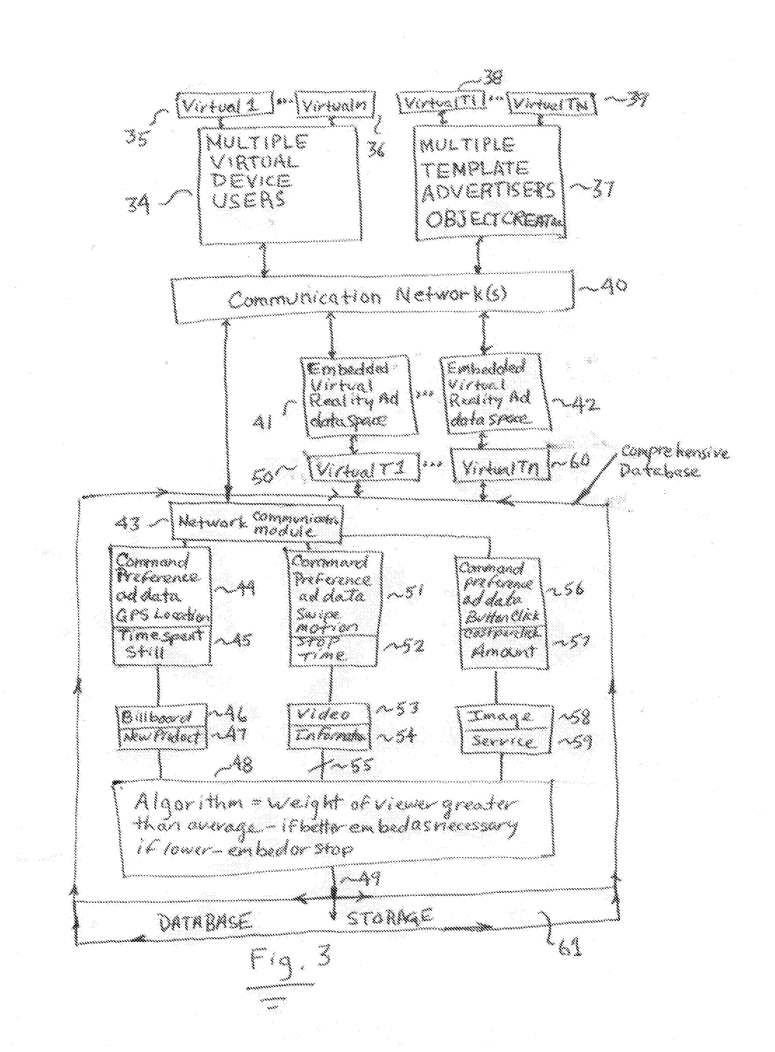

FIG. 3 has multiple virtual device users 34 from virtual 1 35 to virtual n 36 and multiple creative advertisement object user advertiser database application users 37 from virtual T1 38 to virtual Tn 39. A communication network allows all data to flow from 40 and through the network communication module 43, such as, flowing from advertisement object creation 37 to virtual marketplace ad space embedded at virtual reality ad data space of virtual reality program components 41 and 42 for virtual advertisers, virtual T1 50 to Virtual Tn 60, which virtual advertisements are viewed and acted upon through readable database storage 61 at the comprehensive database. The virtual advertisements as embedded 41 to 42, are shown as a advertisement preference command input data GPS 44 time spent at location 45, viewing a virtual billboard 46 of a new product 47 processed by an algorithm 48 for sending to database storage only 61 or also to embed space again at 41 to 42 as the type of tracked product class matches virtual T1 to Virtual Tn of Virtual 1 device to Virtual n device. Advertisement preference command input data swipe motion 51 has a information 54 video 53 stop time 52 that is stopped at 55 as a low algorithm score and sent 49 to database storage earmarked as information videos with similar attributes become less attractive for the virtual reality marketplace. Advertisement preference command input data button click 56 is a cost per click ad of an amount 57 and also an image ad 58 which is a tracked service 59 for redistribution 49 to the marketplace at virtual T1 50 to Virtual Tn 60 of data space 41 and 42 of virtual reality device users 34 at virtual 1 device 35 to virtual n device 36.

1. A computer software system, having a method of utilizing at least one advertisement preference command input data within the at least one advertising database application within at least one portion of virtual reality comprising:
I.) At least one advertisement object is cast or fixed for at least one first user;
II.) The at least one first user responds with advertisement preference command input data and at least a second user of at least one similar advertisement object follows suit;
III.) An algorithm determines who in answer is better for the advertisement object by processing the at least one advertisement preference command input data;
Wherein at least one of the first users at least one virtual reality device will receive the result of the advantage preferred advertisement object.

2. A computer software system, having a method of utilizing at least one advertisement preference command input data within the at least one advertising database application within at least one portion of virtual reality comprising:
I.) At least one database software coded application for advertisement object creation for the at least one user advertiser to deliver at least one partly created at least one advertisement object to at least one first user;
II.) The at least one first user responds with advertisement preference command input data and at least a second user of at least one similar advertisement object follows suit;
III.) An algorithm determines who in answer is better for the advertisement object by processing the at least one advertisement preference command input data;
Wherein the advertisement object builds, via writes from the advertising database application, the further attributes and their result is transmitted to database updates to the user advertiser, the user, or stores in the database the advantage preferred advertisement object.

3. A computer software system, having a method of utilizing at least one advertisement preference command input data within the at least one advertising database application within at least one portion of virtual reality comprising:
I.) The preference tracking and ranking of at least one advertising object assigned attributes by an advertiser user or through user's usage;
II.) The at least one first user responds with advertisement preference command input data and at least a second user of at least one similar advertisement object follows suit;
III.) An algorithm determines who in answer is better for the advertisement object by processing the at least one advertisement preference command input data and checking the advertisement object against the database storage at least one similar advertisement objects' attribute;
Wherein the result of at least one advertisement object and its' attributes rank are assigned at least one database storage and at least one advertisement object is transmitted by higher rank to at least one user virtual device to reiterate the user process which may also transmit results to the user advertiser for information.

4. The advertisement preference command input data as in claim 1 wherein the device uses global positioning system.

5. The advertisement preference command input data as in claim 1 wherein the device uses button clicks.

6. The advertisement preference command input data as in claim 1 wherein the device uses speakers and microphones to hear and speak.

7. The advertisement preference command input data as in claim 1 wherein the device uses motion sensors detection.

8. The advertisement preference command input data as in claim 1 wherein the device uses body gestures.

9. The advertisement preference command input data as in claim 1 wherein the device uses peripheral devices.

10. The advertisement preference command input data as in claim 1 wherein the at least one first user responds multiple times alone or at random alongside multiple users of the same capacity to train the advertisement.

11. The advertisement preference command input data as in claim 1 wherein the device uses the value of at least one in-application, music, video or virtual reality purchase of at least one application.

12. The advertisement preference command input data as in claim 1 wherein the device is valued at stop, pause, rewind, skip, yes, no, buy, sell, or other quantifying command.

13. The advertisement preference command input data as in claim 1 wherein the advertisement is cost per click.

14. The advertisement preference command input data as in claim 1 wherein there is at least one in-application purchase of at least one application.

15. The advertisement preference command input data as in claim 1 wherein there is at least one mixed reality or augmented virtual experiences.

16. The advertisement objects as in claim 2 wherein each text, image, 3-D image, virtual reality, and audible transmitting and receiving delivery, are related objects.

17. The preference tracking and ranking of virtual reality advertisement objects as in claim 3 wherein the attribute is a demographic.

18. The preference tracking and ranking of virtual reality advertisement objects as in claim 3 wherein the attribute is a product.

19. The preference tracking and ranking of virtual reality advertisement objects as in claim 3 wherein the attribute is information.

20. The preference tracking and ranking of virtual reality advertisement objects as in claim 3 wherein the attribute is a service.

21. The advertisement preference device command captures new input data as in claim 1 wherein the first user responds with or without prompt through at least one command which results with at least one input data wherein this novel approach has no single more requirement.
